(19) United States
(12) Patent Application Publication
(10) Pub. No.: US 2025/0350446 A1
(43) Pub. Date: Nov. 13, 2025

(54) KEY DISTRIBUTION TO A PROXY SERVER

(71) Applicant: Arqit Limited, London (GB)

(72) Inventors: David Paul Webb, Sussex (GB); Grant Nunn, Warwickshire (GB)

(21) Appl. No.: 18/868,276

(22) PCT Filed: May 22, 2023
(86) PCT No.: PCT/GB2023/051337

§ 371 Date: Nov. 22, 2024

(30) Foreign Application Priority Data
May 23, 2022 (GB) 2207542.8

(51) Int. Cl. H04L 9/08; H04L 9/14

(52) U.S. Cl. CPC H04L 9/0827; H04L 9/0822; H04L 9/0838; H04L 9/0852; H04L 9/14

(57) ABSTRACT

A system and method for distributing an encryption key to a proxy server configured to operate as a proxy for a third-party, including agreeing, between a client device (CD) and a broker device (BD), a common encryption key (CEK) using a third party service and a key ID corresponding to the CEK; storing, at the CD and the BD, respective copies of the encryption keys and the key IDs; transmitting, from the CD to the proxy server, a request, based on one of the key IDs, to establish a secure connection between the CD and the proxy server; transmitting, from the proxy server to the BD, a request for an encryption key based on the key ID associated with the request transmitted from the CD to the BD; verifying that the key ID corresponds to CEK; and after successful verification, receiving, at the proxy server, the corresponding CEK.

### FIELD OF THE INVENTION

The present application relates to methods and systems for distributing an encryption key to a server operating as a proxy, or gateway, for a wider infrastructure that may include one or more broker devices. In particular, although not exclusively, the present invention relates to quantum-secure methods and systems for distributing an encryption key to such a proxy server.

### BACKGROUND TO THE INVENTION

Secure encryption key distribution is a critically important element of safe and secure communications. One potential approach to facilitate secure key distribution is quantum key distribution (QKD). QKD is a secure communication method which implements a cryptographic QKD protocol involving components of quantum mechanics for distributing cryptographic keys between two known communication parties in a quantum computing secure manner. QKD enables the two parties to have a shared random secret key or cryptographic key known only to them, which can then be used to provide mutual cryptographic security between them, such as by encrypting and decrypting messages.

Following the arrival of large-scale quantum computers, classical key exchange methods-such as factorisation or discrete-log based methods-for key agreement will be vulnerable and unable to provide security. QKD offers unconditionally-secure, including quantum computing secure, agreement of keys between two parties. However, QKD methods rely on being performed between the two parties engaged in the communication.

In many cases, communication between two parties is via a proxy server or similar. Proxy servers may take many forms, and may act as a gateway or ingress to one or more computer applications. Currently, in order to avoid the use of an asymmetric-primitive key-exchange protocol (e.g., the Diffie-Hellman protocol, or a similar protocol) between the proxy server and its client, securely distributing an encryption key to a proxy server typically requires the manual keyfill of the key to the proxy server. As the size of distributed computing systems grow, manual keyfill is becoming an increasingly laborious, time consuming, and expensive process.

The inventors have devised the claimed invention in light of the above problems.

The embodiments described below are not limited to implementations which solve any or all of the problems of the known approaches described above.

### SUMMARY OF INVENTION

This Summary is provided to introduce a selection of concepts in a simplified form that are further described below in the Detailed Description. This Summary is not intended to identify key features or essential features of the claimed subject matter; variants and alternative features which facilitate the working of the invention and/or serve to achieve a substantially similar technical effect should be considered as falling into the scope of the invention.

In a general sense, the present disclosure provides methods and systems to securely distribute encryption keys to a server that is acting as a proxy for one of a pair of communicating parties, without needing to resort to manual keyfill techniques.

The invention is defined as set out in the appended set of claims.

In a first aspect of the present invention, there is provided a method for distributing an encryption key to a proxy server configured to operate as a proxy for a third-party, the method comprising: agreeing between a client device and a broker device, one or more common encryption keys using a third party service; agreeing between the client device and the broker device, a key ID corresponding to each of the one or more common encryption keys; storing, at the client device and at the broker device, respective copies of the encryption keys and the key IDs; transmitting, from the client device to the proxy server a request, based on one of the one or more key IDs, to establish a secure connection between the client device and the proxy server; transmitting, from the proxy server to the broker device, a request for an encryption key, the request being based on the key ID that is associated with the request transmitted from the client device to the broker device; verifying that the key ID upon which the request for an encryption key is based corresponds to one of the one or more common encryption keys; and after successful verification that the key ID upon which the request for an encryption key is based corresponds to one of the one or more common encryption keys, receiving, at the proxy server, the corresponding common encryption key.

By implementing the methods described herein, the user of said methods is able to facilitate the secure agreement of an encryption key between the client device and the proxy server so that communications therebetween are securely encrypted without needing to resort to manual keyfill operations and without using asymmetric-primitive key-exchanges which may be susceptible to attack by quantum computers running Shor's algorithm or another similar process. In particular, the methods described herein enable the user to implement symmetric key distribution at scale.

A proxy server can be understood to refer to any suitable proxy server, gateway, load-balancer or ingress that is configured to provide a single point of entry to a plurality of different backend services. In this way, a proxy server could be considered to be an external facing server. A third party service may be a cloud server or service or any suitable service operable by a third party.

In some embodiments, the method may further comprise establishing a client communication channel between the client device and the proxy server for transmitting the request from the client device to the proxy server therethrough.

In some embodiments, the method may further comprise establishing a broker communication channel between the broker device and the proxy server for transmitting the request for an encryption key and/or the corresponding common encryption key therethrough.

In some embodiments, the broker communication channel may include a shared memory.

In some embodiments, the method may further comprise: storing, by the broker device, the one or more common encryption keys in the shared memory; wherein transmitting the request for an encryption key from the proxy server to the broker device comprises: attempting to read, at the proxy server from the shared memory, an encryption key based on one of the one or more key IDs, wherein if said encryption key is one of the one or more common encryption keys, the attempting to read the encryption key is successful.

In some examples, several different encryption keys may be stored in the shared memory. For example, the shared memory may contain the encryption keys encoded as an array of pairs in the form of (keyID, key). Providing a shared memory to the broker communication channel of systems implementing the methods disclosed herein can improve the efficiency of said methods. By storing encryption keys and their corresponding key IDs in the shared memory, the proxy server is able to query and retrieve information from the shared memory. This increases the efficiency of processing the request to establish a secure communication channel between the client device and the proxy server because the proxy server is able to query the shared memory (that the proxy server has access to) with a key ID and subsequently retrieve the corresponding encryption key from the shared memory. This provides a more efficient alternative to querying the broker device directly and requiring the broker device to process each request every time one is made. In other words, providing a shared memory cuts down on the processing required because the broker device is able to store information in the shared memory that can be directly retrieved by the proxy server.

In some embodiments, the broker communication channel may include one or more pipes.

Providing one or more pipes facilitates inter-process communication between the broker device and the proxy server. The one or more pipes provide a means for storing information provided by a transmitting process until they are read by a receiving process. In other words, pipes provide a means for facilitating a queue of information so that it may be processed. For example, the one or more pipes may store the request transmitted from the proxy server until the broker device is ready to process it. Additionally or alternatively, the one or more pipes may store the encryption key to be received by the proxy server until the proxy server is ready to receive and store/process the encryption key.

In some embodiments, the broker communication channel may include a database. In some examples, the database may be a simple-filed database, e.g., SQLite.

In some embodiments, the broker communication channel may include a relational database management system that comprises the database.

In some embodiments, the database may comprise a cache or a distributed cache. Encryption keys may be stored in the cache, said keys may be encrypted or unencrypted. If the keys are encrypted, the cache may be configured such that the encryption keys within the caches are only accessible to the broker device (in some examples, exclusively for ‘write’ operations) and to the proxy server (in some examples, exclusively for ‘read’ operations).

In some embodiments, the method may further comprise: storing, by the broker device, the one or more key IDs and the one or more encryption keys in the database. Transmitting the request for an encryption key, from the proxy server, may include querying the database with the request based on one of the one or more key IDs. Receiving the corresponding common encryption key at the proxy server may include: after successful verification that the key ID upon which the request for an encryption key is based corresponds to the common encryption key, retrieving, by the proxy server, the common encryption key from the database.

Providing a database that can be actively queried by the proxy server can improve the efficiency of the methods described herein. By storing encryption keys in the database, the proxy server is then able to query said database with a request associated with a key ID and retrieve an encryption key corresponding to the key ID. This increases the efficiency of processing the request to establish a secure communication channel between the client device and the proxy server because the proxy server does not need to directly query the broker device and the method does not require the broker device to process each request every time one is made. Instead, the method leverages the power of database management systems and, optionally relational database management systems, to more efficiently facilitate the provision of a broker communication channel that allows for an encryption key to be securely distributed to the proxy server.

In some embodiments, the data stored in the database is encrypted with a key-encryption key (KEK), the key-encryption key being known to the proxy server and the broker device.

In this way, the data stored in the database is held secure to maintain the security of the encryption key. In some examples, only the proxy server and the broker device may “know” the KEK to maximise the security of the data stored in the database. The KEK may, in some examples, be managed by a hardware security module (HSM).

In some embodiments, the proxy server may be connected via one or more further broker communication channels to one or more further respective broker devices, and the methods described herein may be operable to distribute an encryption key to the proxy server from any of the one or more further broker devices.

In this way, the proxy server may be able to receive an encryption key from several different broker devices and client devices. In particular, a plurality of different encryption keys may be securely distributed to the proxy server according to the needs of any of the client devices requesting to establish a secure client communication channel with the proxy server. In other words, the proxy server may transmit the request (associated with the client device's key ID) to each of the broker devices connected to the proxy server and will receive an encryption key only from the broker device whose encryption key corresponds to the key ID of the client device. In this way, the security of the eventually established secure communication channel is ensured.

In a further aspect of the invention, there is provided a method operable by a proxy server configured to operate as a proxy for a third-party, for distributing an encryption key to the proxy server. Said method comprises: receiving, from a client device, a request to establish a secure connection between the client device and the proxy server based on a key ID. The key ID corresponds to a common encryption key, the common encryption key and key ID having been agreed between the client device and the broker device using a third party service. Respective copies of the encryption key and the key ID are stored at the client device and at the broker device. Said method further comprises: transmitting, to the broker device, a request for an encryption key, the request being based on the key ID associated with the request received from the client device; and if the key ID upon which the request for an encryption key is based is successfully verified as corresponding to one of one or more common encryption keys stored by the broker device, receiving the common encryption key.

As discussed above, by implementing the methods described herein, the user of said methods are able to securely receive an encryption key at the proxy server so that communications between the client device and the proxy server are securely encrypted without needing to resort to manual keyfill operations or the use of asymmetric-primitive key-exchange.

As discussed above, in some embodiments, the method may further comprise establishing a client communication between the client device and the proxy server for receiving the request from the client device therethrough.

As discussed above, in some embodiments, the method may further comprise establishing a broker communication channel between the proxy server and the broker device for transmitting the request for an encryption key and/or for receiving the corresponding common encryption key therethrough.

As discussed above, in some embodiments, the broker communication channel may include a shared memory.

In some embodiments, transmitting the request via the broker communication channel may further include: transmitting the request for an encryption key to the shared memory; and wherein receiving the common encryption key comprises: reading, from the shared memory, a stored copy of the corresponding common encryption key.

As discussed above, providing a shared memory to the broker communication channel of proxy servers implementing the methods disclosed herein can improve the efficiency of said methods.

As discussed above, in some embodiments, the broker communication channel may include one or more pipes.

As discussed above, in some embodiments, the broker communication channel may include a database.

As discussed above, in some embodiments, the broker communication channel may include a relational database management system that comprises the database.

As discussed above, in some embodiments, the database may comprise a cache or distributed cache. In some examples, the database may take the form of an HSM.

In some embodiments, one or more key IDs and one or more common encryption keys may be stored in the database by the broker device. Transmitting the request for an encryption key via the broker communication channel may include querying the database with the request based on a key ID. Receiving the corresponding common encryption key may include, after successful verification that the key ID upon which the request for an encryption key is based corresponds to one of the one or more common encryption keys, retrieving the corresponding common encryption key from the database.

As discussed above, in some embodiments, the data stored in the database is encrypted with a key-encryption key (KEK), the key-encryption key being known to the proxy server and the broker device.

As discussed above, providing a database that can be actively queried by the proxy server improves the efficiency of the methods disclosed herein.

As discussed above, in some embodiments, the proxy server may be connected via one or more further broker communication channels to one or more further respective broker devices, and the methods disclosed herein may be operable to distribute an encryption key to the proxy server.

In some embodiments, the proxy server may be any one or more of: an API gateway; a load balancer; a web application firewall; an ingress point; and/or a Kubernetes ingress point.

Each of the above terms may be referred to herein as a “gateway”. As used herein, the term “gateway” is taken to refer to any gateway, proxy, load balancer, web-application firewall, ingress point or other server which routes data traffic. For example, a gateway may route traffic from the internet into a cloud architecture where a TLS connection is terminated at a server. The methods disclosed herein are applicable with a wide range of proxy servers. API gateways are API management tools that sit between the client device and one or more backend services. Load balancers are devices that distribute traffic across a plurality of servers. Web application firewalls (WAFs) are configurable to operate as a gateway to data stored on a web application. Ingress points are network-defined bottlenecks through which all data traffic is required to enter a network. In this way an ingress point is operable as a gateway (i.e. a proxy) to a back-end cloud or network. Kubernetes ingress points is an ingress point configured to manage one or more client devices' access to services included in a Kubernetes cluster.

In some embodiments, each of the one or more common encryption keys and corresponding key IDs may be agreed across a quantum-secure communication channel between the client device and the broker device.

By ensuring that the common encryption keys and corresponding key IDs are generated via a quantum-secure channel, the overall methods described herein are rendered quantum secure. If the encryption keys and key IDs are generated via a QKD process, the nature of the methods disclosed herein are such that the quantum-security of the encryption key and key ID are maintained throughout the process. For the avoidance of doubt, a quantum-secure communication channel need not be a photonic (or similar) communication channel configured to implement quantum key distribution protocols. Instead, the quantum-secure communication channel may be a communication channel suitable for ‘classical’ communications, wherein the communication channel itself is resistant to quantum-based attacks. The communication channel may be made resistant to quantum-based attacks by, for example, being based only on symmetric cryptographic primitives.

In some embodiments, the quantum-secure communication channel may be configured to implement the third party service.

In this way, the quantum-security of the communications between the client device and the proxy server may be implemented without requiring dedicated hardware or bespoke physical software products. Instead, by implementing the quantum-secure communication channel via a cloud service, quantum-security can be attained without imposing undue burden (in terms of physical devices) on the parties seeking to establish quantum-secure communications therebetween.

In a further aspect of the invention, there may be provided a proxy server comprising a processor configured to perform the methods disclosed herein.

In a further aspect of the invention, there may be provided a networked system comprising: a client device, a broker device; and a proxy server as described herein. Said system may be configured to perform the methods disclosed herein.

As discussed above, in some embodiments, the proxy server may be any one or more of: an API gateway; a load balancer; a web application firewall; an ingress point; and/or a Kubernetes ingress point.

In some embodiments, the system may further comprise a quantum-secure communication channel between the client device and the broker device. The system may be configured to agree the one or more common encryption keys and the corresponding one or more key IDs across the quantum-secure communication channel, using the third party service.

As discussed above, in some embodiments, the quantum-secure communication channel may be configured to implement the third party service. This may be a quantum-secure service.

In a further aspect of the invention, there may be provided a computer program comprising instructions which, when the program is executed by a computer, cause the computer to carry out the methods disclosed herein.

In a further aspect of the invention, there may be provided a computer-readable medium comprising instructions which, when executed by a computer cause the computer to carry out the methods disclosed herein.

In an aspect, there is provided a method for distributing an encryption key to a proxy server configured to operate as a proxy for a third-party, the method comprising: agreeing, between a client device and a broker device, one or more common encryption keys using a cloud server; agreeing, between the client device and the broker device, a key ID corresponding to each of the one or more common encryption keys, wherein each of the one or more common encryption keys and corresponding key IDs are agreed across a quantum-secure communication channel between the client device and the broker device, and wherein the quantum-secure communication channel is implemented by the cloud server; storing, at the client device and at the broker device, respective copies of the encryption keys and the key IDs; transmitting, from the client device to the proxy server, a request, based on one of the one or more key IDs, to establish a secure connection between the client device and the proxy server; transmitting, from the proxy server to the broker device, or to a shared memory, or to a database, a request for an encryption key, the request being based on the key ID that is associated with the request transmitted from the client device to the proxy server; verifying that the key ID upon which the request for an encryption key is based corresponds to one of the one or more common encryption keys; and after successful verification that the key ID upon which the request for an encryption key is based corresponds to one of the one or more common encryption keys, receiving, at the proxy server, the corresponding common encryption key.

In an aspect, there is provided a computer-implemented method operable by a proxy server configured to operate as a proxy for a third-party, for distributing an encryption key to the proxy server, the method comprising: receiving, from a client device, a request to establish a secure connection between the client device and the proxy server, based on a key ID, wherein the key ID corresponds to a common encryption key, the common encryption key and key ID having been agreed between the client device and the broker device using a third party service, and wherein respective copies of the encryption key and the key ID are stored at the client device and at the broker device or at shared memory or at a database; transmitting, to the broker device, or to the shared memory, or to the database, a request for an encryption key, the request being based on the key ID associated with the request received from the client device; and if the key ID upon which the request for an encryption key is based is successfully verified as corresponding to one of one or more common encryption keys stored by the broker device, receiving the common encryption key.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible (or non-transitory) storage media include disks, thumb drives, memory cards etc. and do not include propagated signals. The software can be suitable for execution on a parallel processor or a serial processor such that the method steps may be carried out in any suitable order, or simultaneously.

This application acknowledges that firmware and software can be valuable, separately tradable commodities. It is intended to encompass software, which runs on or controls “dumb” or standard hardware, to carry out the desired functions. It is also intended to encompass software which “describes” or defines the configuration of hardware, such as HDL (hardware description language) software, as is issued for designing silicon chips, or for configuring universal programmable chips, to carry out desired functions.

The features and embodiments discussed above may be combined as appropriate, as would be apparent to a person skilled in the art, and may be combined with any of the aspects of the invention except where it is expressly provided that such a combination is not possible or the person skilled in the art would understand that such a combination is self-evidently not possible.

### BRIEF DESCRIPTION OF THE DRAWINGS

Embodiments of the present invention are described below, by way of example, with reference to the following drawings.

FIG. 1 depicts a computing network system according to an embodiment.

FIG. 2a depicts an example of the proxy server of FIG. 1.

FIG. 2b depicts a further example of the proxy server of FIG. 1.

FIG. 3a depicts an example of the broker communication channel of FIG. 1.

FIG. 3b depicts a further example of the broker communication channel of Figure 1.

FIG. 3c depicts a further example of the broker communication channel of FIG. 1.

FIG. 4 depicts a method performed by the client device of FIG. 1.

FIG. 5a depicts a first part of a method performed by the broker device of FIG. 1.

FIG. 5b depicts a second part of a method performed by the broker device of FIG. 1.

FIG. 5c depicts an alternative second part of a method performed by the broker device of FIG. 1.

FIG. 5d depicts a further alternative second part of a method performed by the broker device of FIG. 1.

FIG. 6 depicts a method performed by the proxy server of FIG. 1.

FIG. 7 depicts a method performed by the shared memory of FIG. 3a.

FIG. 8 depicts an overall method performed by the computing network system of FIG. 1.

FIG. 9a depicts a schematic of a computer device configured to operate as the client device of FIG. 1.

FIG. 9b depicts a schematic of a computer device configured to operate as the broker device of FIG. 1.

FIG. 9c depicts a schematic of a computer device configured to operate as the proxy server device of FIG. 1.

Common reference numerals are used throughout the figures to indicate the same or similar features.

### DETAILED DESCRIPTION

Embodiments of the present invention are described below by way of example only. These examples represent the best mode of putting the invention into practice that are currently known to the Applicant although they are not the only ways in which this could be achieved. The description sets forth the functions of the example and the sequence of steps for constructing and operating the example. However, the same or equivalent functions and sequences may be accomplished by different examples.

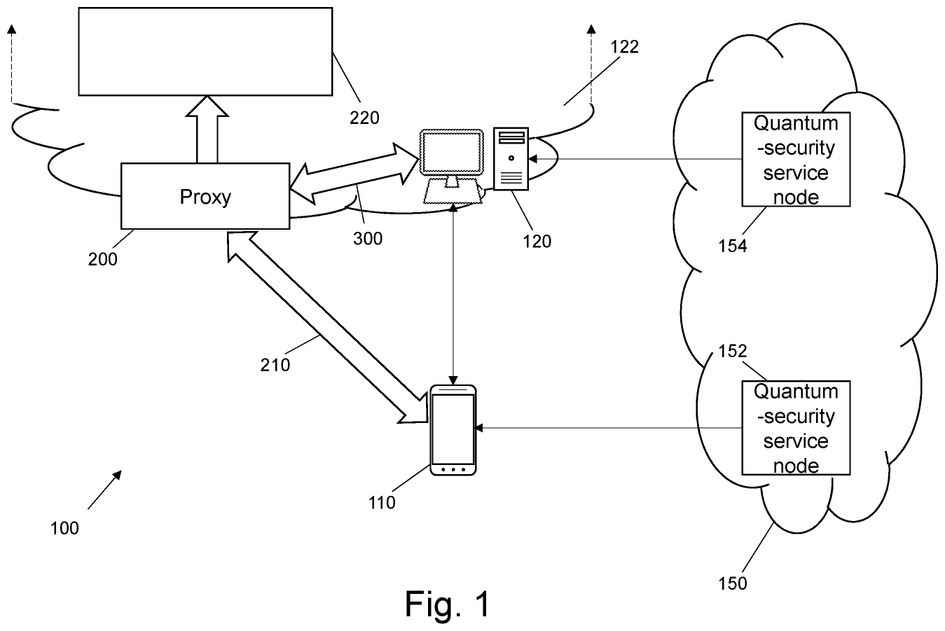

FIG. 1 depicts a computing network system 100 according to an embodiment. Computing network system 100 comprises a client device 110 and a broker device 120. Broker device may be associated with a third party service 122. In some examples the third party service 122 may be a customer cloud, a customer server, a cloud server, or similar. Client device 110 may be any suitable computing device such as a desktop computer or similar. Additionally or alternatively, client device 110 may be a portable device such as a mobile phone, laptop computer, or similar. Similarly, broker device 120 may be any suitable computing device, including a portable device. The broker device 120 may, for example, be a server.

The client device 110 and broker device 120 may be connected to a cloud server 150 configured to provide quantum-security services. As an example, cloud server 150 may be QuantumCloud™ or another similar quantum-secure cloud server. Client device 110 may be connected to the cloud server 150 at a first quantum-security service node 152. Similarly, broker device 120 may be connected to the cloud server 150 at a second quantum-security service node 154.

Client device 110, broker device 120 and cloud server 150 may be communicatively linked. Cloud server 150 may be configured to define a quantum-secure communication channel between the client device 110 and the broker device 120. As discussed in more detail below, client device 110 and broker device 120 may be configured to agree a shared or common quantum-secure encryption key and a key ID corresponding to said key. The encryption key may be a point-to-point (P2P) encryption key or other similar key. By agreeing the shared key via quantum security services, (optionally) defined by the cloud server 150, the encryption key and key ID may be “quantum-secure”, that is, secure against attack by a quantum computer.

For example, when using the QuantumCloud™ to provide the quantum security services, the client device 110 and the broker device 120 and the corresponding first 152 and second 154 quantum-security service nodes located within the QuantumCloud™ may be configured to perform a key exchange protocol for enabling the client device 110 and the broker device 120 to agree on a key (and a key ID) between the client device 110 and the broker device 120.

In order to do this, each quantum-security service node 152 and 154 may have access to the set of keys which are a set of quantum-safe distributed keys. Further, the quantum-security service nodes 152 and 154 may also be in communication over quantum-secure channels to secure servers located within the QuantumCloud™. For example, the first quantum-security service node 152 may be in communication with the first secure server, and the second quantum-security service node 154 may be in communication with a second secure server. Each secure server may include a secure distributed key store for securing a set of quantum distributed keys that will ultimately be distributed to the client device 110 and the broker device 120, and also a quantum transceiver (e.g. an optical quantum transceiver). Each distributed key store may be a Hardware Security Module (HSM) that includes anti-tampering technology that may, for example, wipe quantum distributed keys in case of physical and/or software breach and the like.

The quantum-safe distributed keys may be generated and distributed to each distributed key store using, for example, a terrestrial-based quantum key distribution system configured to perform a terrestrial quantum key distribution protocol for generating and distributing the set of quantum distributed keys using quantum fibre channels and quantum transceivers.

For example, the quantum key distribution protocol implemented by the QuantumCloud™ enables an intermediary device (which may not be part of the QuantumCloud™) to send randomly generated first and second secret symbol strings to the first and the second secure servers, respectively, over respective quantum channels. Further processing of the first and second secret symbol strings may be performed by the intermediary device via respective classical communication channels with the first and second secure serves. The intermediary device may generate a third symbol string for sending via a classical communication channel to the second secure server. The third symbol string may be based on combining a set of symbols of the first secret symbol string with a set of symbols of the second secret symbol string in such a way that enables the second secure server to retrieve a fourth set of symbols based on using its received second symbol string. The combining of the set of symbols of the first secret symbol string and the set of symbols of the second secret symbol string may be based on, for example one-time-pad encryption/decryption, masking, exclusive OR (XOR) operations on bits when symbols converted to bits, or extended XOR operations on symbols or obfuscated set of the first secret symbols. The second secure server may be configured to perform a reverse set of operations to extract a fourth set of symbols using symbols from the successfully received second secret symbol string. The symbols of the fourth set of symbols correspond to symbols of the first set of symbols. From this, the first and second secure serves may perform symbol (or bit) sifting using the received first set of symbols at the first secure server and the fourth set of symbols generated at the second secure server for determining a common set of sifted symbols from which a cryptographic key may be derived and stored (in their respective quantum distributed key stores) by the first and second secure servers. The use of this protocol is not essential, and is presented by way of example. Other protocols may be used in other examples.

In this manner, a quantum-secure communications channel between the client device 110 and the broker device 120 may be defined. Additionally, the first and second secure servers can determine a cryptographic key in a quantum-safe manner even when the intermediary device is not a trusted device. Further detail on this protocol is disclosed in the GB patent GB2590064 titled “Quantum key distribution protocol.”

In addition to the broker device 120, a proxy server 200 is associated with the customer server/cloud 122. Proxy server 200 may be operable as a gateway (for example an API gateway) or similar to the third party service 122. In particular, proxy server 200 may be operable as a gateway to one or more backend services and/or applications 220.

Client device 110 is connected to proxy server 200 by a client communication channel 210. Client device 110 is configured to transmit a request to the proxy server 200 via the client communication channel 210 to enable a secure connection between the client device 110 and the proxy server 200. In effect this facilitates a secure connection between the client device 110 and the one or more backend services and/or applications 220 that are accessible through the proxy server 200. The secure connection may be implemented using TLS, IPSec or any other suitable protocol. TLS 1.3 PSK allows for the communication of a PSK (pre-shared key) ID in the TLS ‘handshakes’. The request is based on a key ID previously agreed and stored by the client device 110 and the broker device 120, as discussed above. Said key ID corresponds to the shared encryption key agreed by the client device 110 and broker device 120 via the cloud server 150, which may be referred to as a pre-shared key (PSK). Importantly, the encryption key itself is not transmitted to the proxy server 200 by the client device 110 via the client communication channel 210.

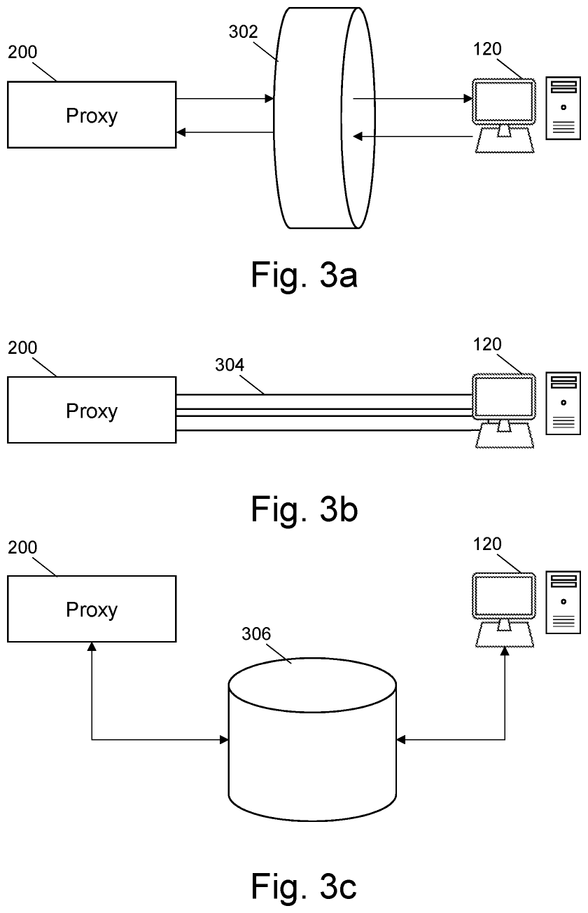

Proxy server 200 is also connected to the broker device 120 by a broker communication channel 300. Proxy server is configured to transmit a request towards the broker device 120 via the broker communication channel 300. Said request may be a request for the key associated with the key ID on which the request from the client device 110 to the proxy server 200 is based. As will be discussed in more detail below, in some embodiments, the request from the proxy server 200 to the broker device 120 need not arrive at the broker device 120 itself. Instead there may be an intermediary device or component such as a shared memory or a database, as will be discussed below in relation to FIGS. 3a to 3c. In some embodiments, however, the request (or a signal indicative of said request) may be transmitted directly to the broker device 120 via the broker communication channel 300.

The broker device 120 or, where applicable, the intermediary device/component mentioned above, is configured to verify that the key ID upon which the request is based corresponds to the encryption key stored by the broker device 120. If the verification is successful, i.e. it is found that the key ID upon which the request is based does correspond to the encryption key stored by the broker device 120, then the proxy server 200 is configured to receive a copy of the encryption key via the broker communication channel 300. The proxy server 200 may receive said copy either directly from the broker device 120 or, where applicable, the intermediary device/component. If the verification is unsuccessful, i.e. it is found that the key ID upon which the request is based does not correspond to the encryption key stored by the broker device 120, then the encryption key will not be transmitted, and the request made to the proxy server 200 from the client device 110 will fail.

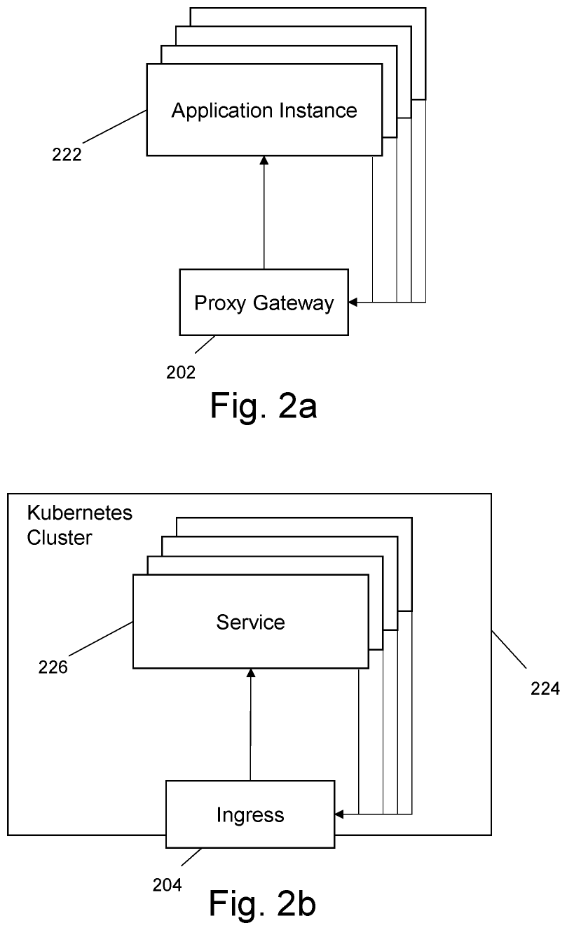

FIG. 2a depicts an example of the proxy server 200 and associated backend services or applications 220 shown in FIG. 1. In the example depicted in FIG. 2a, proxy server 200 is a proxy gateway 202. For example, proxy gateway 202 may be an API gateway or similar. As discussed above, API gateways are API management tools that sit between the client and broker devices 110 and 120 and one or more backend services or applications 220. Each backend service or application 220, as depicted in FIG. 2a, may be an application instance 222. In other words, proxy gateway 202 may manage the receipt and processing of requests to initiate a particular instance of a given application, i.e. an application instance 222.

FIG. 2b depicts a further example of the proxy server 200 and associated backend services 220 shown in FIG. 1. In the example depicted in FIG. 2b, and in contrast to FIG. 2a, proxy server 200 is an ingress 204 to a Kubernetes cluster 224. Kubernetes cluster 224 may comprise one or more services 226. In other examples, cluster 224 may be an alternative computing environment to a Kubernetes cluster. In other words, proxy server 200 need not necessarily be a Kubernetes ingress 204 but may instead be an ingress to any appropriate computing environment. As discussed above, an ingress is operable as a gateway to a backend cloud or network. Kubernetes ingress points, such as ingress 204 are specifically configured to manage one or more client devices' access to services 226 included in a Kubernetes cluster 224.

FIG. 3a depicts an example of the broker communication channel 300 shown in FIG. 1. As depicted in FIG. 3a, broker communication channel 300 may comprise a shared memory 302.

The shared memory 302 is shared between the proxy server 200 and the broker device 120. As discussed above client device 110 is configured to transmit a request to establish a secure connection with proxy server 200 to the proxy server 200 via the client communication channel 210. The request is based on the key ID generated jointly by the client device 110 and broker device 120. In examples where the broker communication channel 300 comprises shared memory 302, the proxy server may be configured to request the key from the shared memory 302.

If the request is based on a key ID which has been previously agreed between the client device 110 and the broker device 120, then the shared memory 302 will contain a copy of said encryption key that can be read directly from the shared memory 302 by the proxy server 200. If the key ID upon which the request is based does not correspond to an encryption key stored by the shared memory 302, then no encryption key can be read by proxy server 200 from the shared memory and the request will fail.

FIG. 3b depicts a further example of the broker communication channel 300 shown in FIG. 1. As depicted in FIG. 3b, broker communication channel 300 may comprise one or more pipes 304. In the example depicted in FIG. 3b, broker communication channel comprises two pipes 304. The pipes 304 may be anonymous pipes or named pipes.

Each of the pipes 304 is a one-way communication channel. For example, proxy server 200 may be configured to transmit the request (or a signal indicative of said request, for example the key ID specified in the request) through a first pipe to the broker device 120. Upon successful verification of the request, as described above, the broker device 120 may be configured to transmit a copy of the encryption key to the proxy server 200 through a second pipe. Additionally or alternatively, the one or more pipes 304 may be replaced with a two-way communication channel, such that the request (or signal indicative thereof) transmitted from the proxy server 200 to the broker device 120 and the copy of the encryption key transmitted from the broker device 120 to the proxy server 200 may be transmitted through the same communication channel.

FIG. 3c depicts a further example of the broker communication channel 300 shown in FIG. 1. As depicted in FIG. 3c, broker communication channel 300 may comprise a database 306. Database 306 may be part of a relational database management system. It may be desirable for the database to be a lightweight, fast-response database such as SQLite. Additionally or alternatively, it may be desirable for the database to comprise a cache or distributed cache, for example a RedisRTM cache.

The broker device 120 may be configured to transmit a copy of the encryption key to database 306 for storage. Proxy server 200 may be configured to query database 306 with the request transmitted from the client device 110 (or a query representative of said request). Database 306 may then be configured to verify that the key ID upon which the request and/or query is based corresponds to an encryption key stored in the database 306. To facilitate this, the broker device 120 further stores a copy of the key ID corresponding to the encryption key in the database 306. If the verification is successful, i.e. it is found that the key ID upon which the request and/or query is based does correspond to an encryption key stored by the database 306, then the database 306 is configured to transmit a copy of said encryption key to the proxy server 200. If the verification is unsuccessful, i.e. it is found that the key ID does not correspond to an encryption key stored in the database 306, then no encryption key will be transmitted to the proxy server 200, and the request will fail.

In some examples, the data stored in the database 306 may be encrypted with a key-encryption key. The key-encryption key may be known to the broker device 120 and the proxy server 200 and, optionally, only to the broker device 120 and the proxy server 200. In some examples, the key-encryption key may be managed by an HSM. This may ensure an improved level of security for the encryption key(s) being transmitted to the proxy server 200.

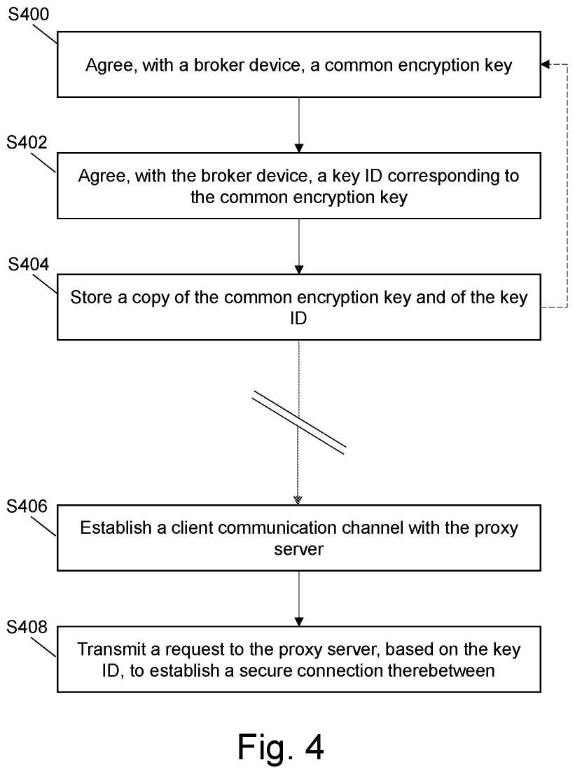

FIG. 4 depicts a method performed by the client device 110 shown in FIG. 1. In a first operation, S400, client device 110 agrees a common encryption key together with broker device 120. The common encryption key may be agreed via a quantum-secure communication channel that facilitate quantum-security services, for example, cloud server 150.

Simultaneously with operation S400 or subsequently, in operation S402, client device 110 agrees a key ID corresponding to the common encryption key with the broker device 120. As with the encryption key, the key ID may be agreed via a quantum-secure communication channel, for example, cloud server 150. In some examples, the client device 110 may agree, with the broker device 120, an expiry time for the common encryption key, i.e., a time after which the common encryption key will not be used by either the client device 110 or the broker device 120. This may serve to further enhance the security of communications as providing a finite lifetime for an encryption key reduces the risk of the encryption keys being actively used by the client device 110 and broker device 120 from being obtained by a third party.

In operation S404, client device 110 stores a copy of the common encryption key and of the key ID, for example in a memory (or other secure storage, such as an enclave) of the client device 110.

Operations S400 to S404 may be repeated any number of times to build up a store of agreed common encryption keys and corresponding key IDs. Additionally, different subsets of the plurality of agreed common encryption keys may be agreed by the client device 110 with respectively different broker devices 120.

In operation S406, client device 110 establishes a client communication channel 210 with a proxy server 200.

In operation S408, client device 110 transmits a request to the proxy server 200, through the client communication channel 210, to establish a secure connection between the client device 110 and the proxy server 200. The request is based, at least in part, on the key ID stored by the client device 110. The request may be part of a handshake as part of the TLS 1.3 protocol. Importantly, client device 110 does not transmit its copy of the encryption key to the proxy server 200 directly.

Operations S406 and S408 may be performed asynchronously with operations S400 to S404, as indicated by the broken arrow shown in FIG. 4. In other words, the second part of the method of FIG. 4, including operations S406 and S408 may be performed separately from the first part of the method that includes operations S400 to S404. In some examples, operations S406 and S408 are carried out after one or more iterations of operations S400 to S404. In other words, the request to establish a secure connection between the client device 110 and the proxy server 200 may be based on one of a plurality of key IDs, wherein the key ID upon which the request is based corresponds to one of a plurality of encryption keys that have been agreed between the client device 110 and one or more broker devices 120.

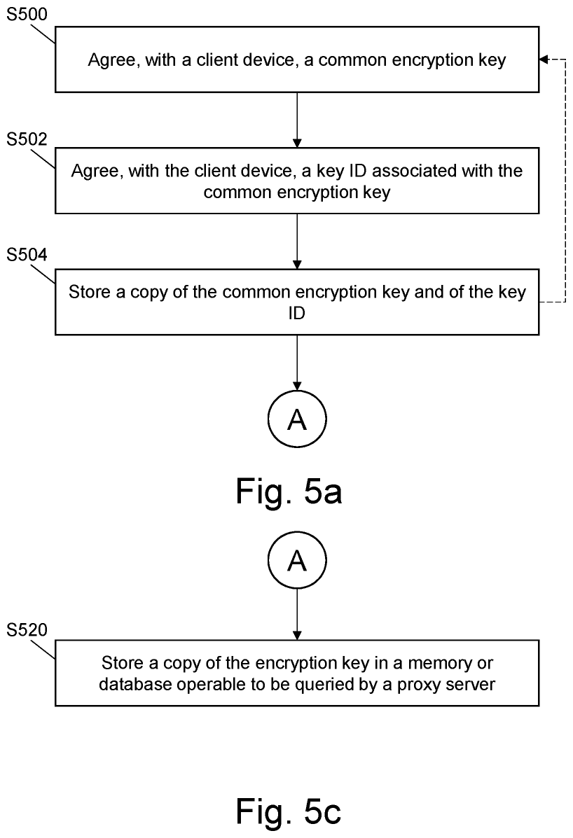

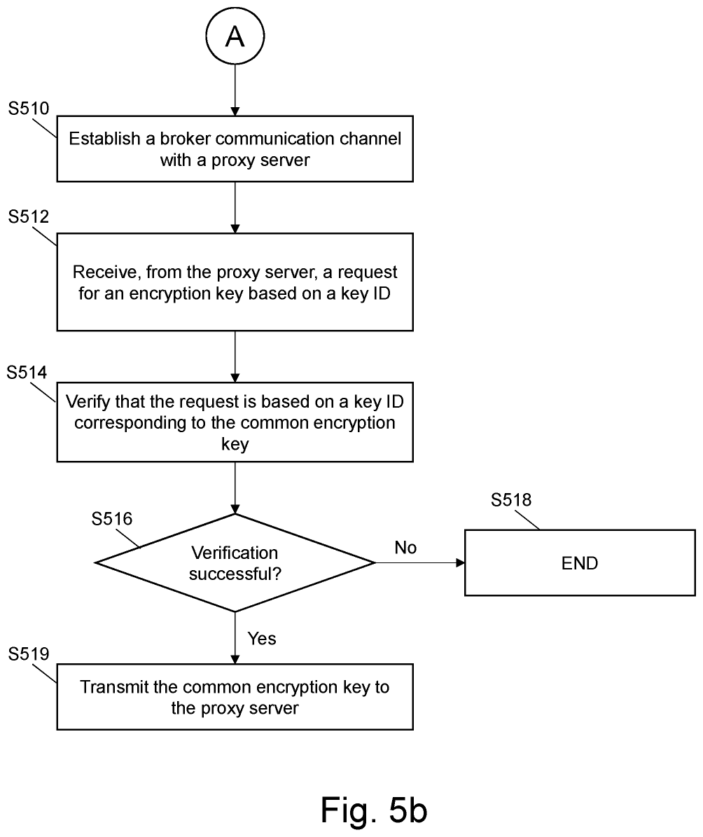

FIG. 5a depicts a first part of a method performed by the broker device 120 shown in FIG. 1. In a first operation S500, broker device 120 agrees a common encryption key together with client device 110. The common encryption key may be agreed via a quantum-secure communication channel that facilitate quantum-security services, for example, cloud server 150.

Simultaneously with operation S500 or subsequently, in operation S502, broker device 120 agrees a key ID corresponding to the common encryption key together with client device 110. As with the encryption key, the key ID may be agreed via a quantum-secure communication channel, for example, cloud server 150. In some examples, the broker device 120 may agree, with the client device 110, an expiry time for the common encryption key, i.e., a time after which the common encryption key will not be used by either the client device 110 or the broker device 120. This may serve to further enhance the security of communications as providing a finite lifetime for an encryption key reduces the risk of the encryption keys being actively used by the client device 110 and broker device 120 from being obtained by a third party.

In operation S504, broker device 120 caches or stores a copy of the common encryption key and of the key ID, for example in a memory of the broker device 120.

Operations S500 to S504 may be repeated any number of times to build up a store of agreed common encryption keys and corresponding key IDs. Additionally, operations S500 to S504 may be performed by a plurality of different broker devices 120 wherein each respective broker device 120 agrees, with the client device 110, a different subset of a plurality of agree common encryption keys.

FIG. 5b depicts an example of a second part of a method performed by the broker device 120 shown in FIG. 1. Following the method shown in FIG. 5a, in operation S510, broker device 120 establishes a broker communication channel 300 with a proxy server 200.

In operation S512, broker device 120 receives, from the proxy server 200 and through the broker communication channel 300, a request for an encryption key. The request is based, at least in part, on a key ID stored by the client device 110.

In operation S514, following the receipt of the request for an encryption key based on the key ID, broker device 120 verifies that the request is based on a key ID corresponding to an encryption key that is common to client device 110 and broker device 120.

In operation S516, it is determined if the verification is successful or unsuccessful. If the verification is unsuccessful, i.e. it is determined that the key ID upon which the request is based does not correspond to an encryption key stored by the broker device 120, then no encryption key is transmitted by the broker device 120 and the method performed by the broker device 120 is ended at S518. As a result, the request by the client device 110 to the proxy server 200 to create a tunnel between the client device 110 and the proxy server 200 fails.

If, however, the verification is successful, i.e. it is determined that the key ID upon which the request is based does correspond to the encryption key stored by the broker device 120, then, as shown in operation S519, broker device 120 transmits the common encryption key to the proxy server 200, via the broker communication channel 300.

FIG. 5c depicts an alternative example of a second part of a method performed by the broker device 120 shown in FIG. 1. In such an example, the broker device 120 and proxy server 200 are connected by a broker communication channel 300 that comprises a shared memory 302 database 306. The database 306 may be part of a relational database management system, for example SQLite. Following the method shown in FIG. 5a, in operation S520, broker device 120 stores a copy of the encryption key in the shared memory 302 or database 306. Shared memory 302 or Database 306 is operable to be queried by the proxy server 200. Broker device 120 also stores a copy of the key ID in the shared memory 302 or database 306. Further, in some instances, the data stored in database 306 may be encrypted with a key-encryption key that is known to the broker device 120 and the proxy server 200 and, optionally known only to the broker device 120 and the proxy server 200. As discussed above, the key-encryption key may be managed by an HSM.

The methods depicted in FIGS. 5b and 5c may be performed asynchronously with the method shown in FIG. 5a. In other words, the second part of the exemplary method (shown in FIG. 5b or 5c) may be performed separately from the first part of the exemplary method (shown in FIG. 5a). In some examples, the method depicted in FIG. 5b or 5c is carried out after one or more iterations of the method depicted in FIG. 5a. In other words, the operation of transmitting, by the broker device 120, a copy of a given encryption key to the proxy server 200 may be carried out after selecting the given encryption key from amongst a plurality of common encryption keys that have been agreed between one or more client devices 110 and one or more broker devices 120 based on a key ID that corresponds to said given encryption key.

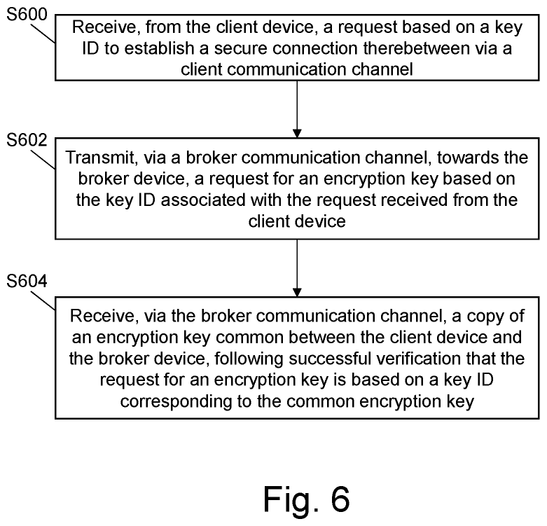

FIG. 6 depicts a method performed by the proxy server 200 shown in FIG. 1. Firstly, in operation S600, proxy server 200 receives, from client device 110, a request to establish a secure connection between the client device 110 and the proxy server 200 via a client communication channel 210. The request is based, at least in part, on a key ID that corresponds to an encryption key that is common to the client device 110 and a broker device 120.

Subsequent to operation S600, in operation S602, proxy server 200 transmits, via a broker communication channel 300, towards the broker device 120 and/or an intermediary device/component disposed in the broker communication channel 300, a request for an encryption key based on the key ID associated with the request received from the client device 110. Broker communication channel 300 may include an intermediary device and/or component between the proxy server 200 and the broker device 120. In some examples, as discussed above, broker communication channel 300 comprises a shared memory 302 that is shared between the proxy server 200 and the broker device 120. In some examples, as discussed above, broker communication channel 300 comprises one or more pipes 304. In some examples, as discussed above, broker communication channel 300 comprises a database 306. Said database 306 may be part of a relational database management system.

In operation S604, subsequent to a method or methods performed elsewhere to verify that the key ID upon which the request for an encryption key is based corresponds to the encryption key stored by the broker device 120, proxy server 200 receives, via the broker communication channel 300, a copy of an encryption key that is common to the client device 110 and broker device 120. Operation S604 is performed only following successful verification that the request is based on a key ID corresponding to said common encryption key.

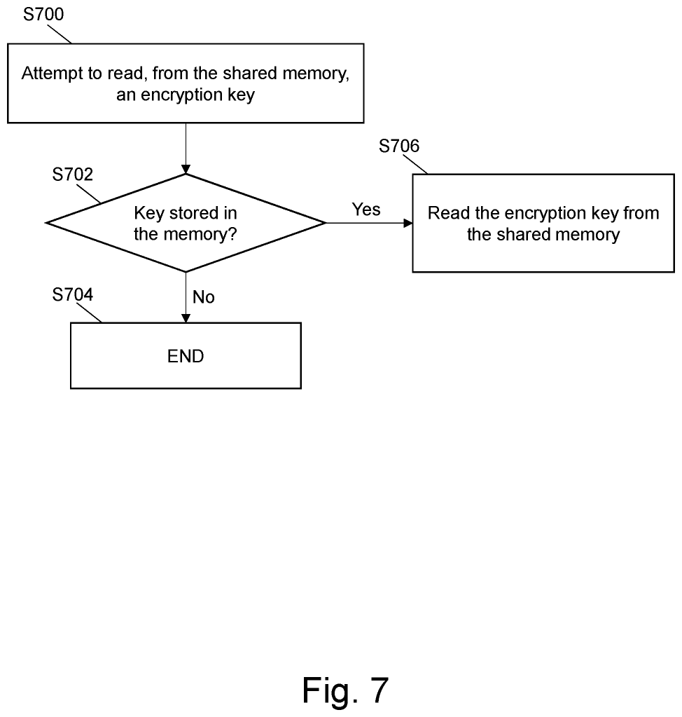

FIG. 7 depicts a method performed by the proxy server 200 shown in FIG. 3a. The proxy server 200 is linked to a shared memory 302 that is shared between broker device 120 and proxy server 200, as discussed above. Firstly, in operation S700, proxy server 200 attempts to read, from the shared memory 302, an encryption key. The attempt to read an encryption key may be based on a key ID corresponding to said encryption key. For example, the key ID may be used as a reference to find the corresponding encryption key within the shared memory 302.

In operation S702, it is determined whether the encryption key that the proxy server 200 is attempting to read from the shared memory 302 is actually stored within the shared memory 302. This determination may be based, for example, on using the key ID corresponding to the encryption key as a look-up reference, e.g., by searching through the shared memory 302 to find the key ID corresponding to the encryption key.

If it is determined that the encryption key that the proxy server 200 is attempting to read from the shared memory 302 is not stored in the shared memory 302, then no encryption key is read out from the shared memory 302 and the method performed by the proxy server 200 is ended at S704. As a result, in effect, the request for an encryption key fails.

If, however, the determination is successful, i.e. it is determined that the encryption key that the proxy server 200 is attempting to read from the shared memory 302 is stored in the shared memory 302, then the proxy server 200 reads said encryption key out from the shared memory 302.

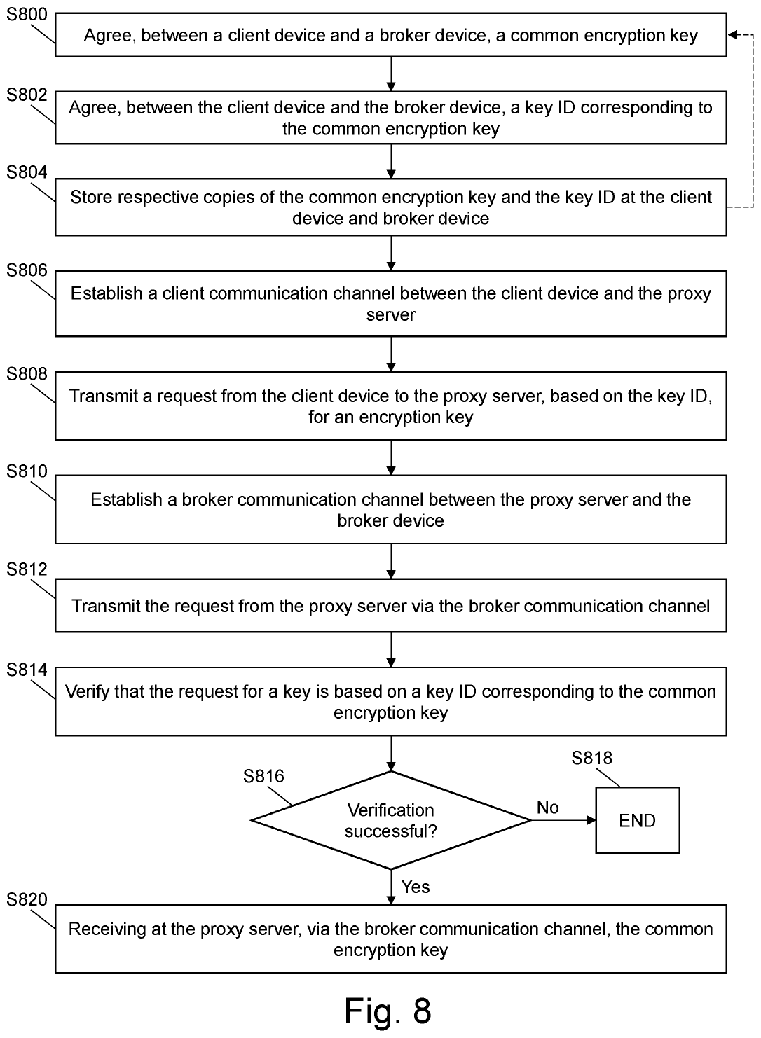

FIG. 8 depicts a method performed by the computing network system 100 shown in FIG. 1. Firstly, in operation S800, a client device 110 and broker device 120, agree between themselves a common encryption key. The encryption key may be agreed via a quantum-secure communication channel, for example a cloud server 150.

Prior to, simultaneously with, or subsequent to operation S800, in operation S802, client device 110 and broker device 120, agree between themselves a key ID corresponding to the common encryption key. Similar to the encryption key, the key ID may be agreed via a quantum-secure communication channel, for example cloud server 150.

In operation S804, respective copies of the encryption key and of the key ID are stored at both the client device 110 and the broker device 120.

Operations S800 to S804 may be repeated any number of times to build up a store of agreed common encryption keys and corresponding key IDs. Additionally, different subsets of the plurality of agreed common encryption keys may be agreed by one or more different client devices 110 with respectively different broker devices 120.

In operation S806, the client device 110 and a proxy server 200 establish a client communication channel 210 therebetween.

In operation S808, client device 110 transmits a request to the proxy server 200 through the client communication channel 210 for an encryption key. The request is based, at least in part, on the key ID stored by the client device 110.

In operation S810, the proxy server 200 and the broker device 120 establish a broker communication channel 300 therebetween. The broker communication channel 300 may include an intermediary device or component. For example, the broker communication channel 300, as discussed above, may comprise a shared memory 302 that is shared between the proxy server 200 and the broker device 120. Additionally or alternatively, the broker communication channel 300 may comprise one or more pipes 304. Additionally or alternatively, the broker communication channel 300 may comprise a database 306. Said database may be part of a relational database management system, for example SQLite.

Subsequent to receiving the request from the client device 110, and as shown in operation S812, proxy server transmits a request for the specified key (based on the key ID) via the broker communication channel 300 to the broker device 120 and/or an intermediary device/component as appropriate.

In operation S814, the broker device 120 and/or an intermediary device/component disposed in the broker communication channel 300 verifies that the request for a key is based on a key ID corresponding to the common encryption key stored in the broker device 120.

In operation S816, it is determined if the verification was successful. If the verification is unsuccessful, i.e. it is determined that the key ID upon which the request is based does not correspond to the encryption key stored by the broker device 120 (and/or the intermediary device/component as appropriate), then no encryption key is transmitted to the proxy server 200 and the method is ended at S818.

If, however, it is determined that the verification is successful, i.e. it is determined that the key ID upon which the request is based does correspond to the encryption key stored by the broker device 120, then, as shown in operation S820, the proxy server 200 receives, via the broker communication channel 300, said common encryption key.

Operations S806 to S820 may be performed asynchronously with operations S800 to S804. In other words, the second part of the method of FIG. 4, including operations S806 to S820, may be performed separately from the first part of the method that includes operations S800 to S804. In some examples, operations S806 to S820 are carried out after one or more iterations of operations S800 to S804. In other words, the request to establish a secure connection between the client device 110 and the proxy server 200 may be based on one of a plurality of key IDs, wherein the key ID upon which the request is based corresponds to one of a plurality of encryption keys that have been agreed between the client device 110 (amongst one or more client devices 110) and one or more broker devices 120.

As will be apparent to the skilled person, the operations of the methods shown in FIGS. 4 to 8 need not necessarily be performed in the order depicted in said Figures. The skilled person will understand that, except where specifically prohibited or evidently impossible, the different operations may be performed in any suitable order.

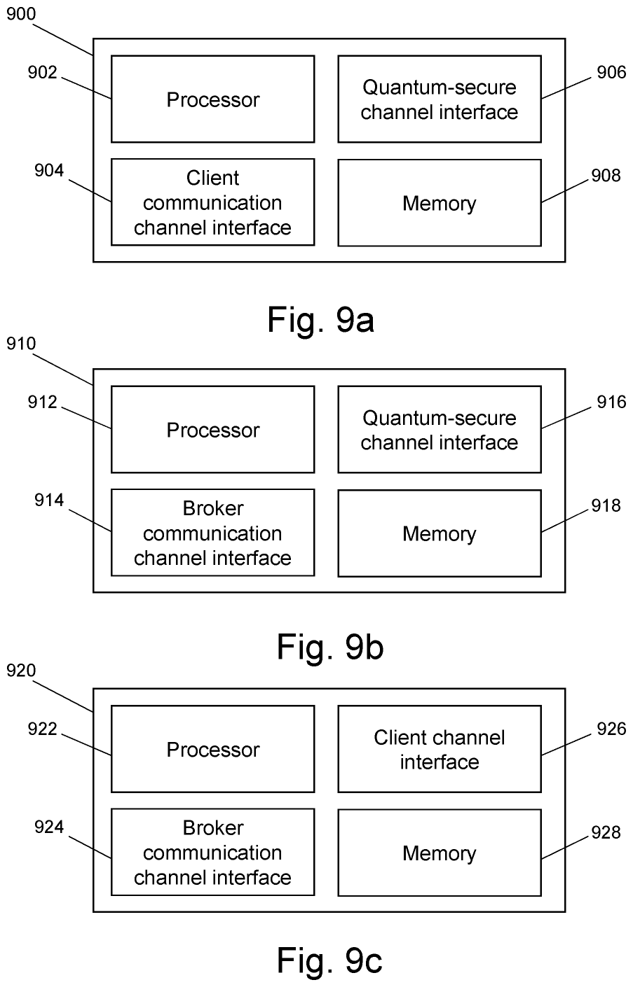

FIG. 9a depicts a schematic of a computer device 900 configured to operate as the client device 110 shown in FIG. 1. Computer device 900 comprises a processor 902, a client communication channel interface 904, a quantum-secure channel interface 906, and a memory 908. Processor 902 is configured to execute a computer program, or similar, to perform the methods disclosed herein. Client communication channel interface 904 defines an interface between computer device 900 and the client communication channel 210, thereby connecting computer device 900 to a proxy server 200 that may be implemented as part of a further computer device, as discussed below in relation to FIG. 9c. Quantum-secure channel interface 906 defines an interface between computer device 900 and the quantum-secure communication channel (for example, cloud server 150), thereby connecting computer device 900 to a broker device 120 that may be implemented as part of a further computer device, as discussed in relation to FIG. 9b. Memory 908 may store a copy of the common encryption key and the corresponding key ID, as discussed above, and may further store any additional data and/or executable logic.

FIG. 9b depicts a schematic of a computer device 910 configured to operate as the broker device 120 shown in FIG. 1. Computer device 910 comprises a processor 912, a broker communication channel interface 914, a quantum-secure channel interface 916, and a memory 918. Processor 912 is configured to execute a computer program, or similar, to perform the methods disclosed herein. Broker communication channel interface 914 defines an interface between computer device 910 and the broker communication channel 300, thereby connecting computer device 910 to a proxy server 200 that may be implemented as part of a further computer device, as discussed below in relation to FIG. 9c. Quantum-secure channel interface 916 defines an interface between computer device 910 and the quantum-secure communication channel (for example, cloud server 150), thereby connecting computer device 910 to a client device 110 that may be implemented as part of a further computer device 900, as discussed above in relation to FIG. 9a. Memory 908 may store a copy of the common encryption key and the corresponding key ID, as discussed above, and may further store any additional data and/or executable logic.

FIG. 9c depicts a schematic of a computer device 920 configured to operate as the proxy server 200 shown in FIG. 1. Computer device 920 comprises a processor 912, a broker communication channel 924, a client channel interface 926, and a memory 928. Processor 922 is configured to execute a computer program, or similar, to perform the methods disclosed herein. Broker communication channel interface 924 defines an interface between computer device 920 and the broker communication channel 300, thereby connecting computer device 920 to a broker device 120 that may be implemented as part of a further computer device 910, as discussed above in relation to FIG. 9b. Client channel interface 926 defines an interface between computer device 920 and the client communication channel 210, thereby connecting computer device 920 to a client device 110 that may be implemented as part of a further computer device 900, as discussed above in relation to FIG. 9a. Memory 908 may store a copy of the common encryption key and the corresponding key ID, and of any requests received via the client channel interface 926, as discussed above. Memory 908 may further store any additional data and/or executable logic.

In some embodiments, the proxy server(s) and cloud server(s) described herein may be replaced with alternatives such as any suitable computing device, e.g. a computer or mobile device or similar.

In the embodiments described above, the server may comprise a single server or network of servers. In some examples, the functionality of the server may be provided by a network of servers distributed across a geographical area, such as a worldwide distributed network of servers, and a user may be connected to an appropriate one of the network servers based upon, for example, a user location.

The above description discusses embodiments of the invention with reference to a single user for clarity. It will be understood that in practice the system may be shared by a plurality of users, and possibly by a very large number of users simultaneously.

The embodiments described above are fully automatic. In some examples a user or operator of the system may manually instruct some steps of the method to be carried out.

In the described embodiments of the invention the system may be implemented as any form of a computing and/or electronic device. Such a device may comprise one or more processors which may be microprocessors, controllers or any other suitable type of processors for processing computer executable instructions to control the operation of the device in order to gather and record routing information. In some examples, for example where a system on a chip architecture is used, the processors may include one or more fixed function blocks (also referred to as accelerators) which implement a part of the method in hardware (rather than software or firmware). Platform software comprising an operating system or any other suitable platform software may be provided at the computing-based device to enable application software to be executed on the device.

Various functions described herein can be implemented in hardware, software, or any combination thereof. If implemented in software, the functions can be stored on or transmitted over as one or more instructions or code on a computer-readable medium. Computer-readable media may include, for example, computer-readable storage media. Computer-readable storage media may include volatile or non-volatile, removable or non-removable media implemented in any method or technology for storage of information such as computer readable instructions, data structures, program modules or other data. A computer-readable storage media can be any available storage media that may be accessed by a computer. By way of example, and not limitation, such computer-readable storage media may comprise RAM, ROM, EEPROM, flash memory or other memory devices, CD-ROM or other optical disc storage, magnetic disc storage or other magnetic storage devices, or any other medium that can be used to carry or store desired program code in the form of instructions or data structures and that can be accessed by a computer. Disc and disk, as used herein, include compact disc (CD), laser disc, optical disc, digital versatile disc (DVD), floppy disk, and blu-ray (RTM) disc (BD). Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, DSL, or wireless technologies such as infrared, radio, and microwave are included in the definition of communication medium. Combinations of the above should also be included within the scope of computer-readable media.

Alternatively, or in addition, the functionality described herein can be performed, at least in part, by one or more hardware logic components. For example, and without limitation, hardware logic components that can be used may include Field-programmable Gate Arrays (FPGAs), Program-specific Integrated Circuits (ASICs), Program-specific Standard Products (ASSPs), System-on-a-chip systems (SOCs). Complex Programmable Logic Devices (CPLDs), etc.

Although illustrated as a single system, it is to be understood that the computing device may be a distributed system. Thus, for instance, several devices may be in communication by way of a network connection and may collectively perform tasks described as being performed by the computing device.

Although illustrated as a local device it will be appreciated that any of the computing devices may be located remotely and accessed via a network or other communication link (for example using a communication interface).

The term ‘computer’ is used herein to refer to any device with processing capability such that it can execute instructions. Those skilled in the art will realise that such processing capabilities are incorporated into many different devices and therefore the term ‘computer’ includes PCs, servers, mobile telephones, personal digital assistants and many other devices.

Those skilled in the art will realise that storage devices utilised to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realise that by utilising conventional techniques known to those skilled in the art that all, or a portion of the software instructions may be carried out by a dedicated circuit, such as a DSP, programmable logic array, or the like.

It will be understood that the benefits and advantages described above may relate to one embodiment or may relate to several embodiments. The embodiments are not limited to those that solve any or all of the stated problems or those that have any or all of the stated benefits and advantages. Variants should be considered to be included into the scope of the invention.

Any reference to ‘an’ item refers to one or more of those items. The term ‘comprising’ is used herein to mean including the method steps or elements identified, but that such steps or elements do not comprise an exclusive list and a method or apparatus may contain additional steps or elements.

As used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices.

Further, as used herein, the term “exemplary” is intended to mean “serving as an illustration or example of something”.

Further, to the extent that the term “includes” is used in either the detailed description or the claims, such term is intended to be inclusive in a manner similar to the term “comprising” as “comprising” is interpreted when employed as a transitional word in a claim.

Moreover, the acts described herein may comprise computer-executable instructions that can be implemented by one or more processors and/or stored on a computer-readable medium or media. The computer-executable instructions can include routines, sub-routines, programs, threads of execution, and/or the like. Still further, results of acts of the methods can be stored in a computer-readable medium, displayed on a display device, and/or the like.

The order of the steps of the methods described herein is exemplary, but the steps may be carried out in any suitable order, or simultaneously where appropriate. Additionally, steps may be added or substituted in, or individual steps may be deleted from any of the methods without departing from the scope of the subject matter described herein. Aspects of any of the examples described above may be combined with aspects of any of the other examples described to form further examples without losing the effect sought.

It will be understood that the above description of a preferred embodiment is given by way of example only and that various modifications may be made by those skilled in the art. What has been described above includes examples of one or more embodiments. It is, of course, not possible to describe every conceivable modification and alteration of the above devices or methods for purposes of describing the aforementioned aspects, but one of ordinary skill in the art can recognize that many further modifications and permutations of various aspects are possible. Accordingly, the described aspects are intended to embrace all such alterations, modifications, and variations that fall within the scope of the appended claims.

1-34. (canceled)

35. A method for distributing an encryption key to a proxy server configured to operate as a proxy for a third-party, the method comprising:
agreeing, between a client device and a broker device, one or more common encryption keys using a third party service;
agreeing, between the client device and the broker device, a key ID corresponding to each of the one or more common encryption keys;
storing, at the client device and at the broker device, respective copies of the encryption keys and the key IDs;
transmitting, from the client device to the proxy server, a request, based on one of the one or more key IDs, to establish a secure connection between the client device and the proxy server;
transmitting, from the proxy server to the broker device, a request for an encryption key, the request being based on the key ID that is associated with the request transmitted from the client device to the broker device;
verifying that the key ID upon which the request for the encryption key is based corresponds to one of the one or more common encryption keys; and
after successful verification that the key ID upon which the request for the encryption key is based corresponds to one of the one or more common encryption keys, receiving, at the proxy server, the corresponding common encryption key.

36. The method according to claim 35, further comprising establishing a client communication channel between the client device and the proxy server for transmitting the request from the client device to the proxy server therethrough.

37. The method according to claim 35, further comprising establishing a broker communication channel between the broker device and the proxy server for transmitting the request from the proxy server to the broker device and/or the corresponding common encryption key therethrough.

38. The method according to claim 37, wherein the broker communication channel comprises a shared memory.

39. The method according to claim 38, further comprising:
storing, by the broker device, the one or more common encryption keys in the shared memory;
wherein transmitting the request for the encryption key from the proxy server to the broker device comprises:
attempting to read, at the proxy server from the shared memory, an encryption key,
wherein if said encryption key is one of the one or more common encryption keys, the attempting to read the encryption key is successful.

40. The method according to claim 37, wherein the broker communication channel includes one or more pipes.

41. The method according to claim 37, wherein the broker communication channel includes a database.

42. The method according to claim 41, wherein the broker communication channel includes a relational database management system that comprises the database.

43. The method according to claim 41, wherein the database comprises a cache or distributed cache.

44. The method according to claim 41, further comprising:
storing, by the broker device, the one or more key IDs and the one or more encryption keys in the database;
wherein transmitting the request for the encryption key, from the proxy server, includes querying the database with the request based on one of the one or more key IDs; and
wherein receiving the corresponding common encryption key at the proxy server includes, after successful verification that the key ID upon which the request for the encryption key is based corresponds to the common encryption key, retrieving, by the proxy server, the common encryption key from the database.

45. The method according to claim 44, wherein the data stored in the database is encrypted with a key-encryption key, the key-encryption key being known to the proxy server and the broker device.

46. The method according to claim 45, wherein the proxy server is connected via one or more further broker communication channels to one or more further respective broker devices, and wherein the method according to any preceding claim is operable to distribute an encryption key to the proxy server from any of the one or more further broker devices.

47. A computer-implemented method operable by a proxy server configured to operate as a proxy for a third-party, for distributing an encryption key to the proxy server, the method comprising:
receiving, from a client device, a request to establish a secure connection between the client device and the proxy server, based on a key ID,
wherein the key ID corresponds to a common encryption key, the common encryption key and key ID having been agreed between the client device and the broker device using a third party service, and
wherein respective copies of the encryption key and the key ID are stored at the client device and at the broker device;
transmitting, to the broker device, a request for an encryption key, the request being based on the key ID associated with the request received from the client device; and
if the key ID upon which the request for the encryption key is based is successfully verified as corresponding to one of one or more common encryption keys stored by the broker device, receiving the common encryption key.

48. The method according to claim 47, further comprising establishing a client communication between the client device and the proxy server for receiving the request from the client device therethrough.

49. The method according to claim 47, further comprising establishing a broker communication channel between the proxy server and the broker device for transmitting the request for the encryption key and/or for receiving the corresponding common encryption key therethrough.

50. The method according to claim 49, wherein the broker communication channel includes a shared memory, wherein transmitting the request via the broker communication channel includes:
transmitting the request for the encryption key to the shared memory; and
wherein receiving the common encryption key comprises reading, from the shared memory, a stored copy of the corresponding common encryption key.

51. The method according to claim 49, wherein the broker communication channel includes one or more pipes.

52. The method according to claim 49, wherein the broker communication channel includes a database, wherein the broker communication channel includes a relational database management system that comprises the database.

53. The method according to claim 47, wherein each of the one or more common encryption keys and corresponding key IDs are agreed across a quantum-secure communication channel between the client device and the broker device, wherein the quantum-secure communication channel is configured to implement the third party service.

54. A system comprising:
a client device;
a broker device; and
a proxy sever comprising a processor configured to:
receive, from the client device, a request to establish a secure connection between the client device and the proxy server, based on a key ID,
wherein the key ID corresponds to a common encryption key, the common encryption key and key ID having been agreed between the client device and the broker device using a third party service, and
wherein respective copies of the encryption key and the key ID are stored at the client device and at the broker device;
transmit, to the broker device, a request for an encryption key, the request being based on the key ID associated with the request received from the client device; and
if the key ID upon which the request for the encryption key is based is successfully verified as corresponding to one of one or more common encryption keys stored by the broker device, receive the common encryption key.
